(19) United States
(12) Patent Application Publication
(10) Pub. No.: US 2007/0088237 A1
(43) Pub. Date: Apr. 19, 2007

(54) Inflatable massaging clothes

(76) Inventor: Jimmy Tseng, Fairfax, VA (US)

Correspondence Address: Jimmy Tseng, 12643 Buckleys Gate Drive, Fairfax, VA, 22030, US

(21) Appl. No.: 11/249,836

(22) Filed: Oct. 14, 2005

(51) Int. Cl. A61H 9/00

(52) U.S. Cl. 601/151; 601/148; 601/DIG. 20

(57) ABSTRACT

An inflatable massaging clothes, comprising mainly as air bladder and a housing outside of the air bladder; at least one air valve; and an air pump; wherein the air bladder and the housing are of a general shape of a clothes, having a back portion, a right front portion, and a left front portion. Wherein the left side of the right front portion and the right side of the left front portion are provided with hooks and loops so that the right front portion and the left front portion can be attached together; and wherein a plurality of massage balls are provided on the inside of the back portion, corresponding to some pressure points to be stimulated.

### FIELD OF THE INVENTION

This invention relates to an inflatable massaging clothes (jersey), in particular to an inflatable massaging clothes that can be inflated and deflated alternatively and controllably by the user.

### BACKGROUND OF THE INVENTION

Conventionally, a massaging stick, chair, or bed is used for massaging human arms, back or chest areas. These massaging devices can not provide massage for all areas of human arms, back and chest. Furthermore, the massaging chairs or beds are relatively expensive and can not be easily carried to a different location.

### SUMMARY OF THE INVENTION

An objective of the present invention is to provide as inflatable massaging clothes (jersey) which can provide massage simultaneously for all areas of human arms, back and chest that are accommodated in the clothes.

Another objective of the present invention is to provide an inflatable massaging clothes that is relatively inexpensive and that can be carried to a different location easily.

Yet another objective of the present invention is to provide an inflatable massaging clothes that can be inflated and deflated alternatively and controllably by the user.

### BRIEF DESCRIPTION OF THE DRAWINGS

FIG. 1 is a perspective view of a preferred embodiment of an inflatable massaging clothes of the present invention;

FIG. 2 is a front view of a back portion of the inflatable massaging clothes;

FIG. 3 is a rear view of a back portion of the inflatable massaging clothes;

FIG. 4 is a front view of a right front of the inflatable massaging clothes;

FIG. 5 is a rear view of a right front of the inflatable massaging clothes;

FIG. 6 is a front view of a left front of the inflatable massaging clothes;

FIG. 7 is a rear view of a left front of the inflatable massaging clothes;

FIG. 8 is a perspective view of the inflatable massaging clothes with an inflating means (air pump), and with the longitudinal edge of a right front portion attached to that of a left front portion;

FIGS. 9-12 show different positions of a user using the inflatable massaging clothes, while the user is standing;

FIGS. 13-15 show different positions of a user using the inflatable massaging clothes, while the user is sitting;

FIGS. 16-18 show different positions of a user using the inflatable massaging clothes, while the user is lying down;

FIG. 19 shows a perspective view of air pump used in the present invention;

FIG. 20 shows a perspective view of a portion of the air pump shown in FIG. 19;

FIG. 21 is a perspective view similar to FIG. 20, looking from a difference angle;

FIG. 22 is a top view of the parts shown in FIG. 20;

FIG. 23 is an exploded view of the parts shown in FIG. 20;

FIG. 24 is a longitudinal sectional view of the parts shown in FIG. 20;

FIG. 25 is a top view of the air pump, with a cover installed;

FIG. 26 is a bottom view of the air pump;

FIG. 27 is a schematic view depicting the hand and the air pump; and

FIG. 28 is a similar to FIG. 27, showing different angle.

### DETAILED DESCRIPTION OF THE INVENTION

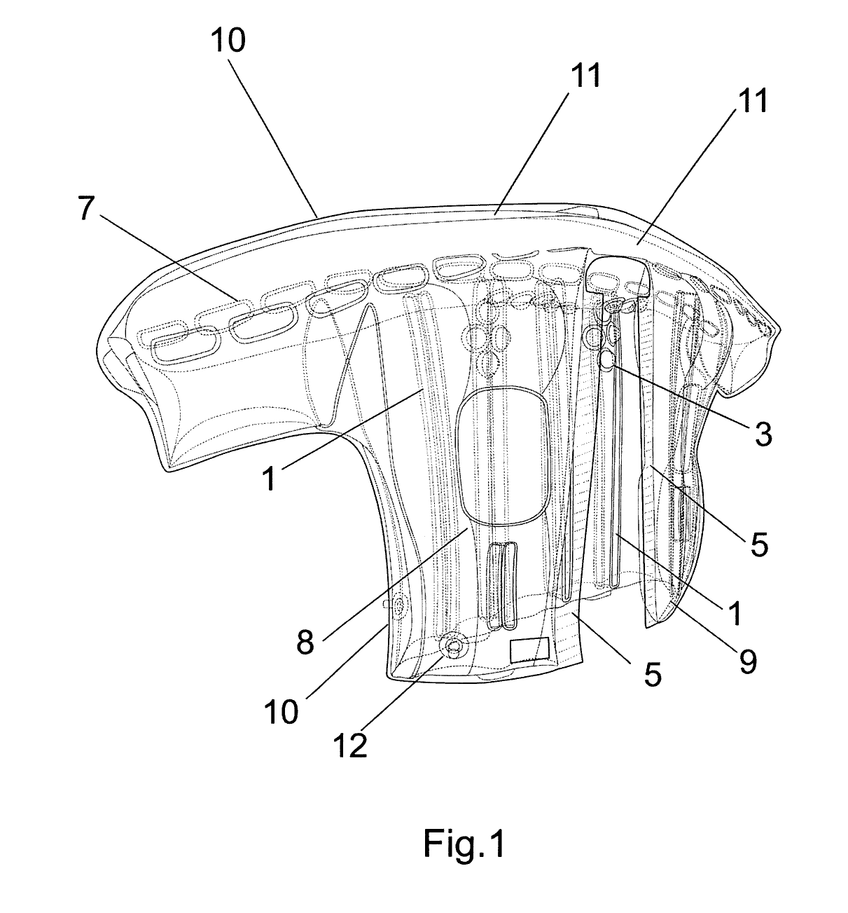

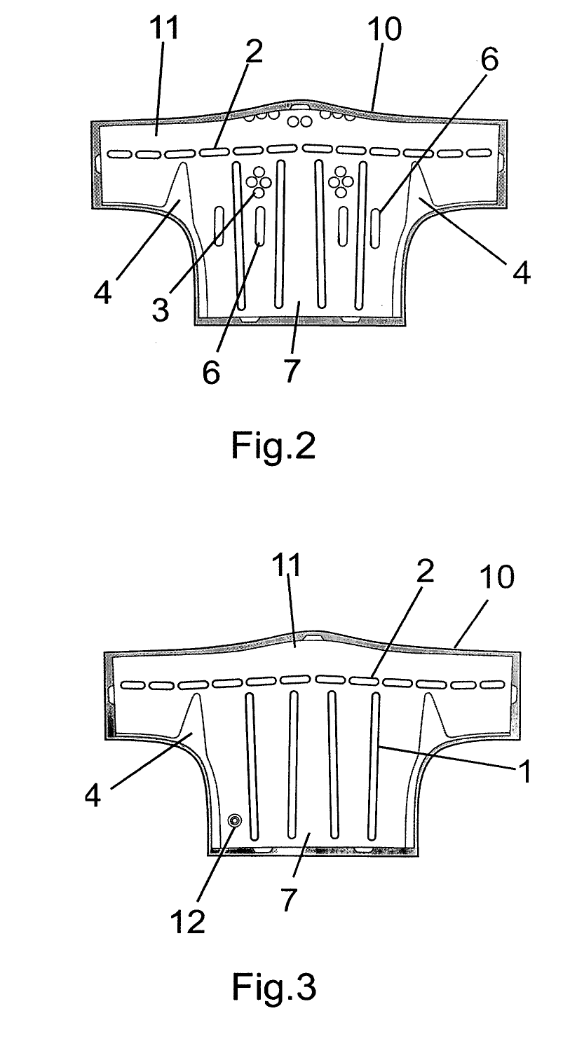

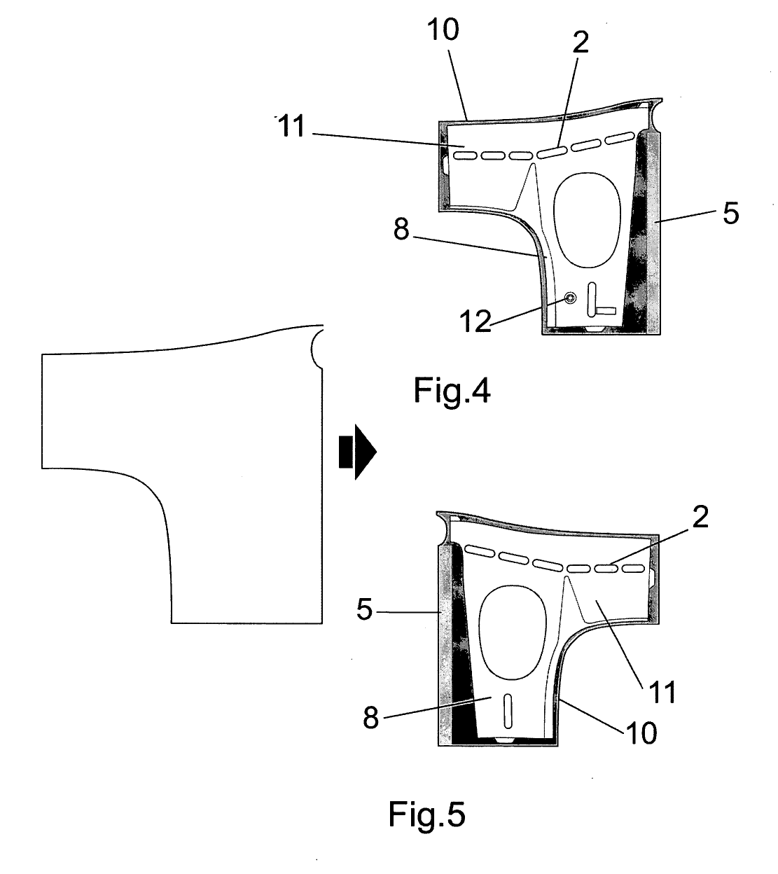

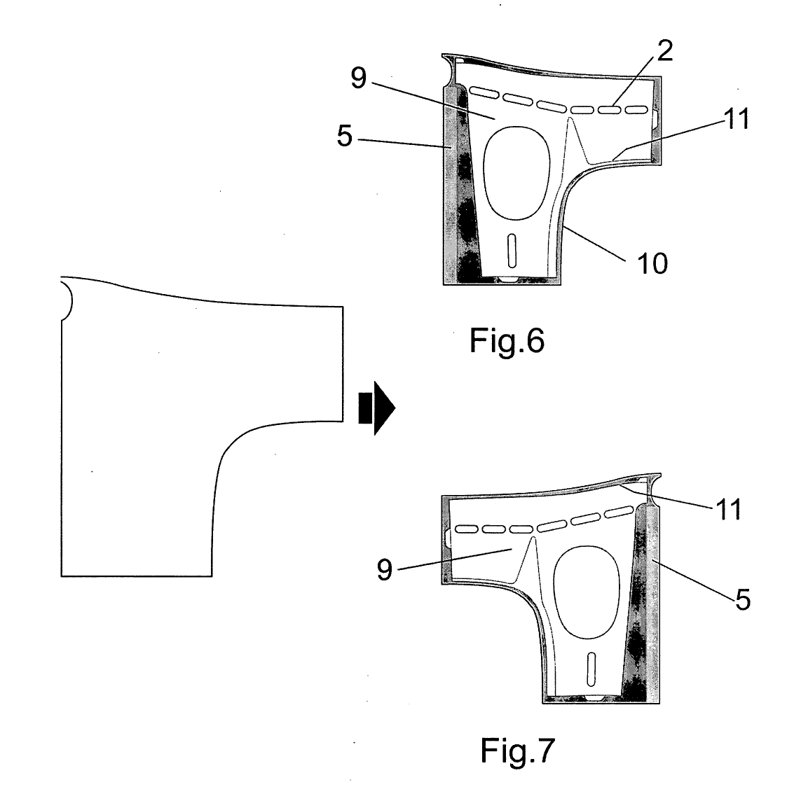

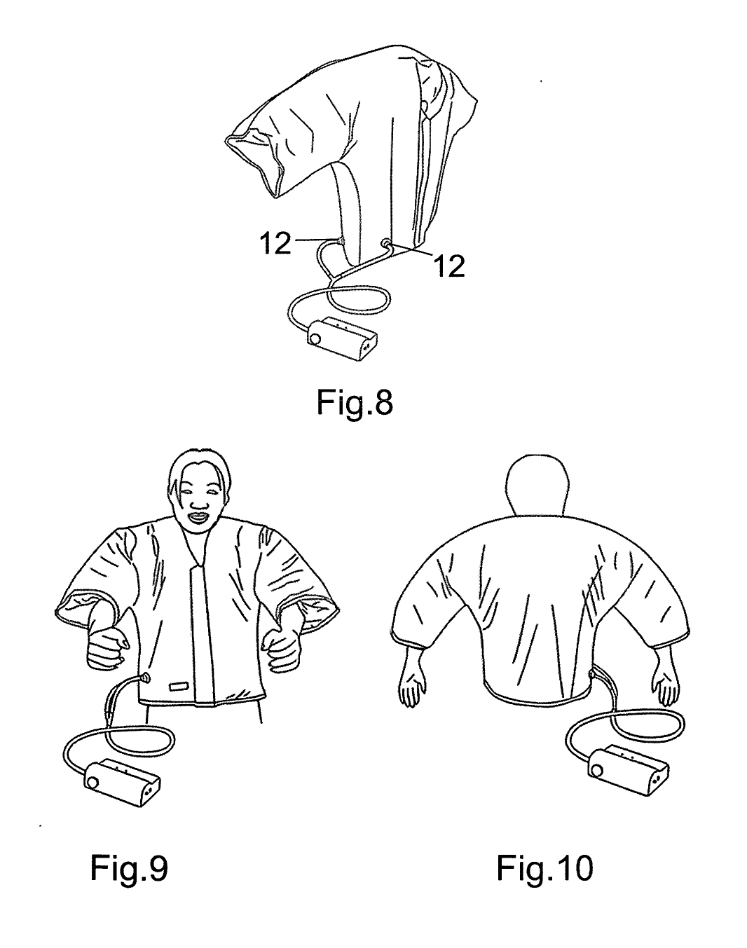

Please see FIGS. 1-7 for the detailed structure of a preferred embodiment of the inflatable massaging clothes of the present invention.

The inflatable massaging clothes comprises mainly an air bladder 11 and a housing (shell) 10, forming a back position 7, a right front portion 8, and a left front portion 9. The three portions 7, 8 and 9 form a shape which looks like a clothes jersey). The inner or outer longitudinal edge of the left portion of the right front portion 8, and the outer or inner longitudinal edge of the right portion of the left front portion 9 are provided with hooks and loops (Velcro) 5 so that the right front portion 8 and the left front portion 9 can be connected together before the inflatable massaging clothes is inflated.

An air valve 12 is provided on the back portion 7 and the right front portion 8. A plurality of massage balls 3 (preferably of semi-spherical shapes) are provided on the inside of the back portion, corresponding to several pressure points of the human back.

A plurality of vertical gussets 1 and shortened vertical gussets 6 are provided on the back portion 7 of the air bladder 10 to keep the back portion 7 in a suitable shape when it is inflated so that the user feel comfortable.

A plurality of horizontal gussets 2 are provided on the upper portions of the back portion 7, the right front portion 8, and the left front portion 9 for connecting two adjacent sheets of the air bladder 11 so that the air bladder 11 can be divided into several air cells to enhance the comfort and massage effect.

There are two uninflated areas 4 at the position of the arm pits and of generally triangular shapes. The purpose of the uninflated areas 4 is to increase the comfort of the user.

The housing (shell) 10 can be made of soft fabric or other suitable material. The air bladder 11 can be made of soft PVC (poly vinyl chloride), TPU (thermoplastic polyurethane), PU (polyurethane), or other suitable material. It is better to allow three fingers of space to between the inflatable massaging clothes and chest before inflation.

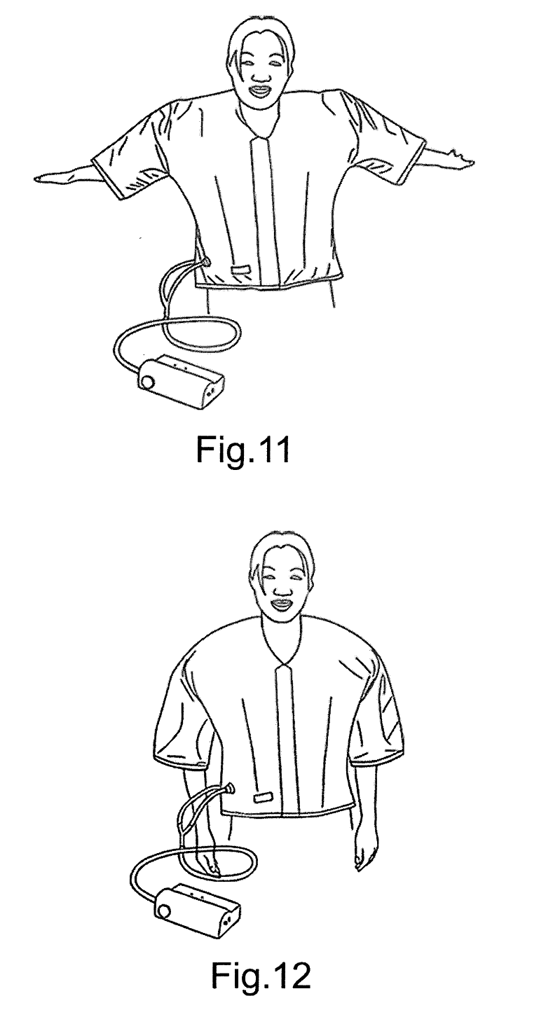

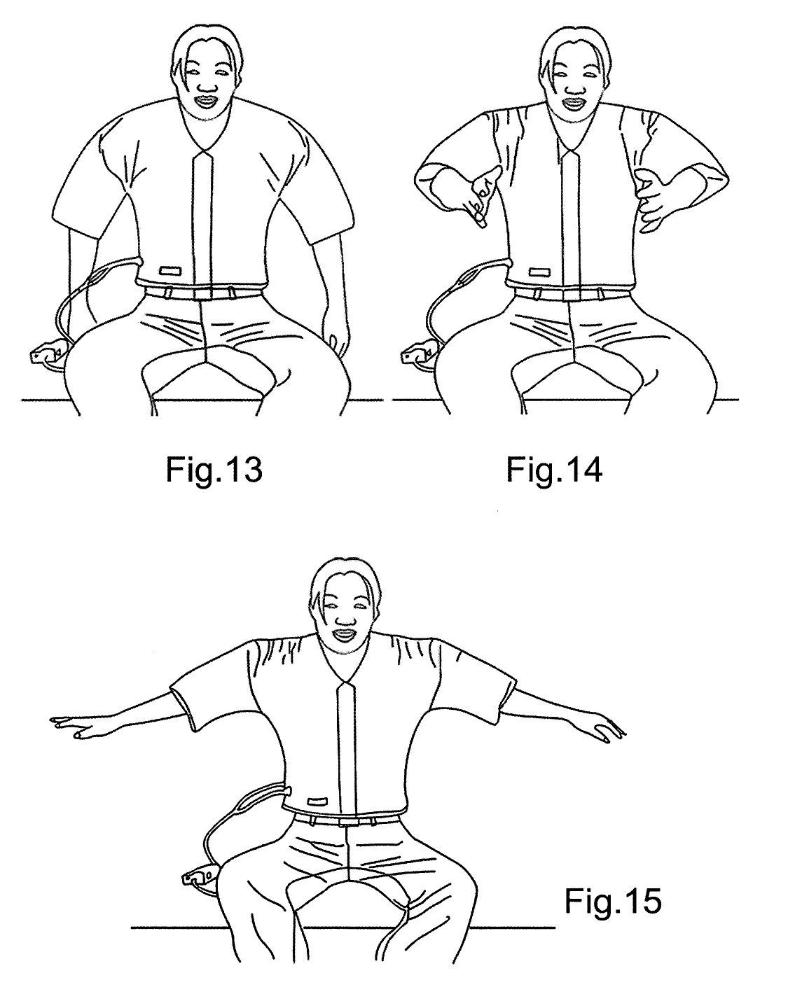

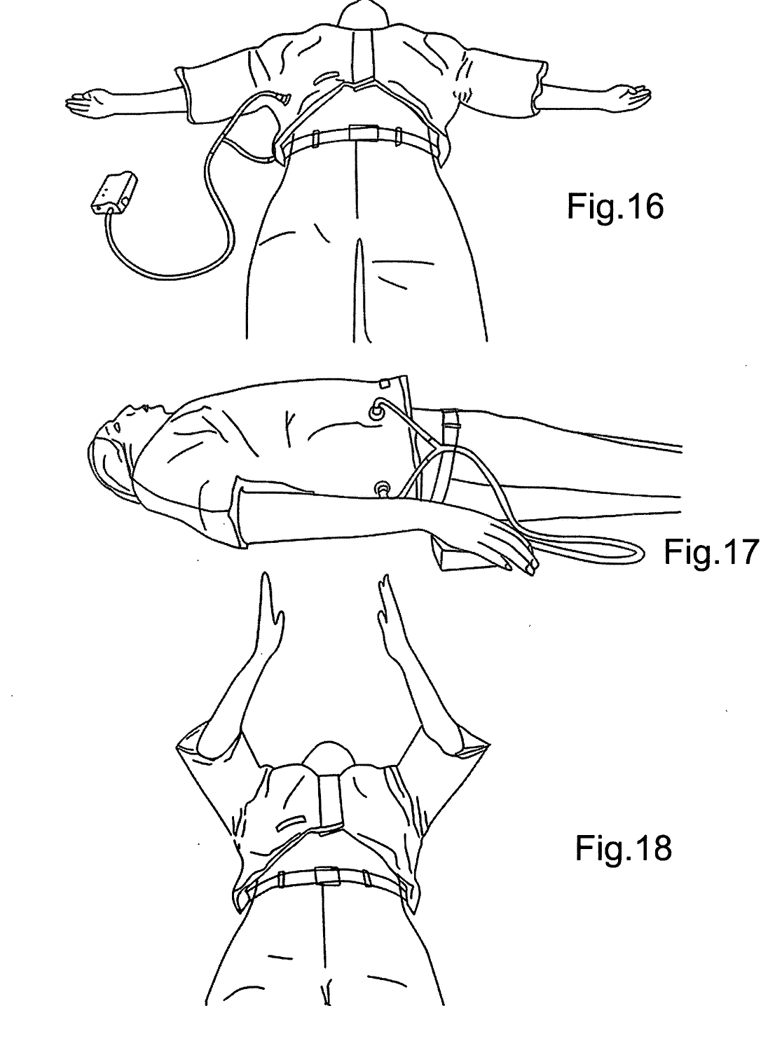

FIGS. 9-18 show different positions of the state of using the inflatable massaging clothes. When the inflatable massaging clothes is inflated, it massages the back, chest, and upper arms of the user, the massage ball 3 stimulate the pressure points of the back and shoulder of the user. When the user moves the arms of the upper body, the massaging and the stimulating effects can be enhanced.

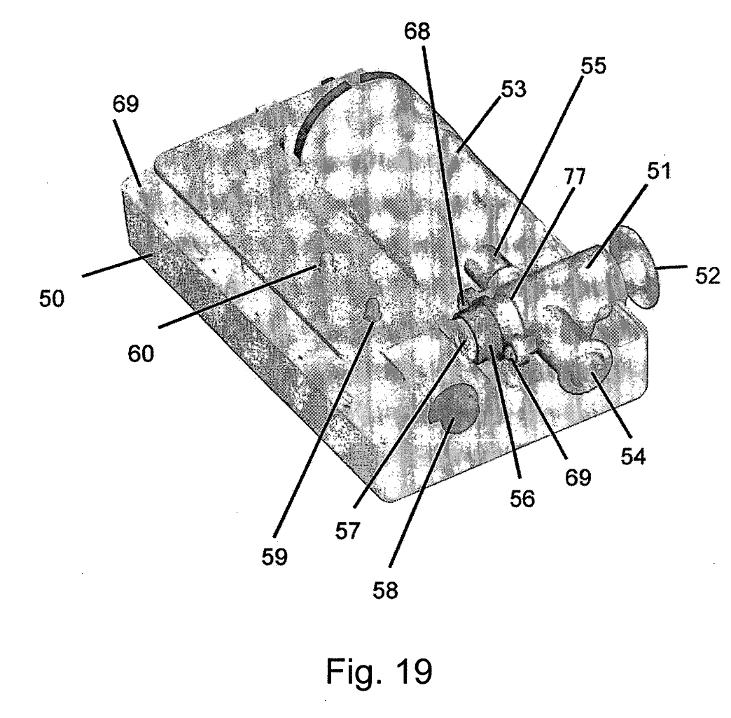

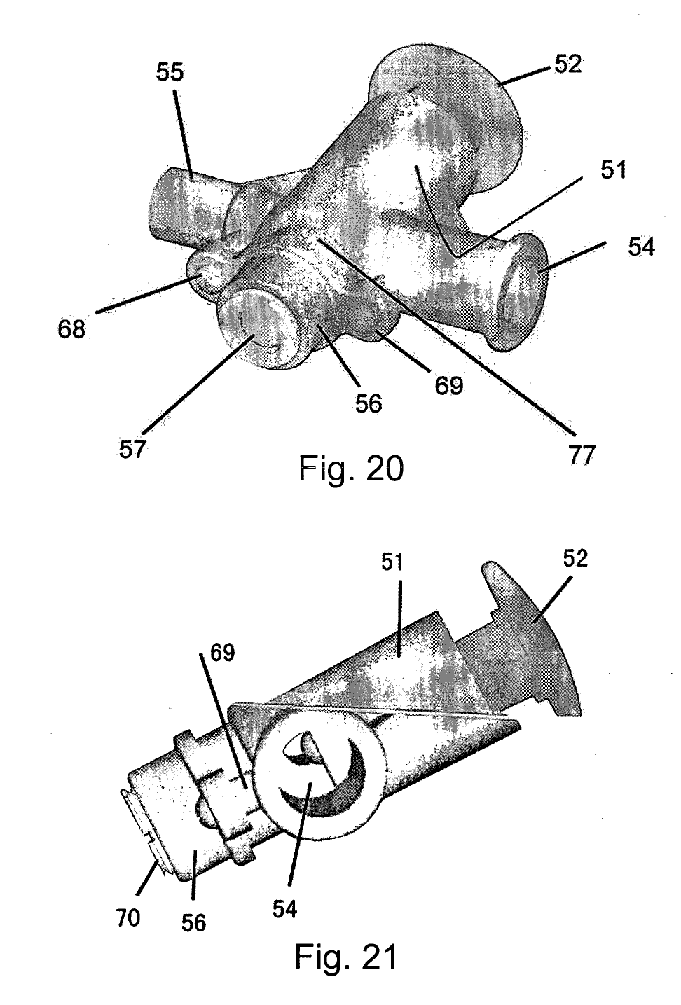

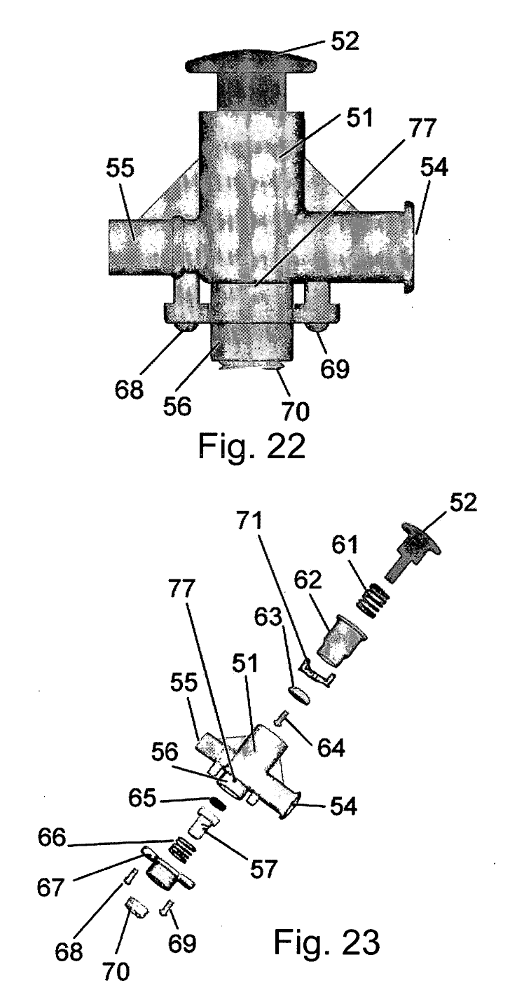

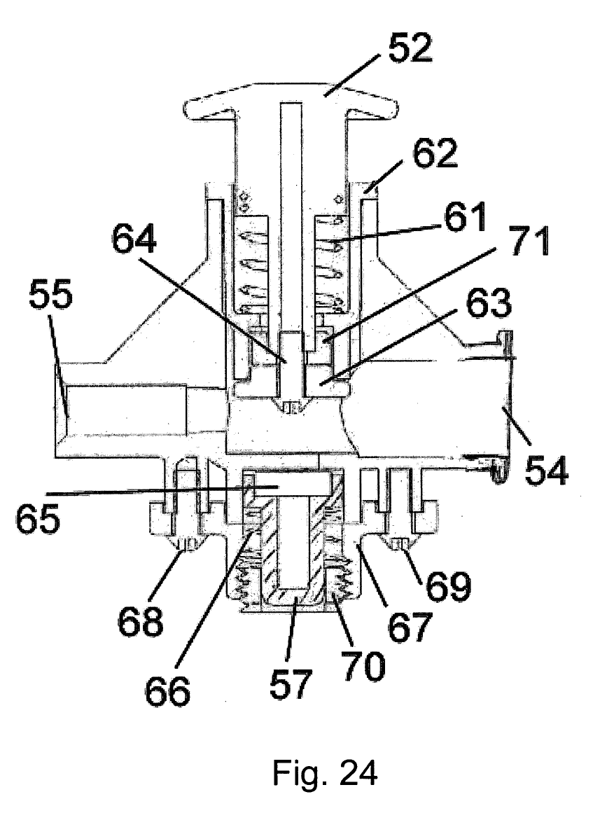

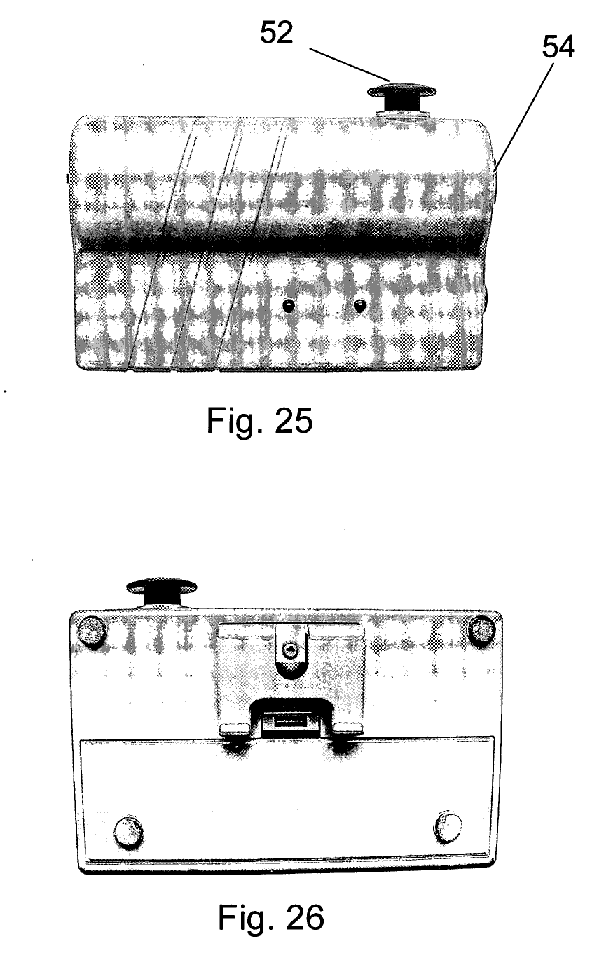

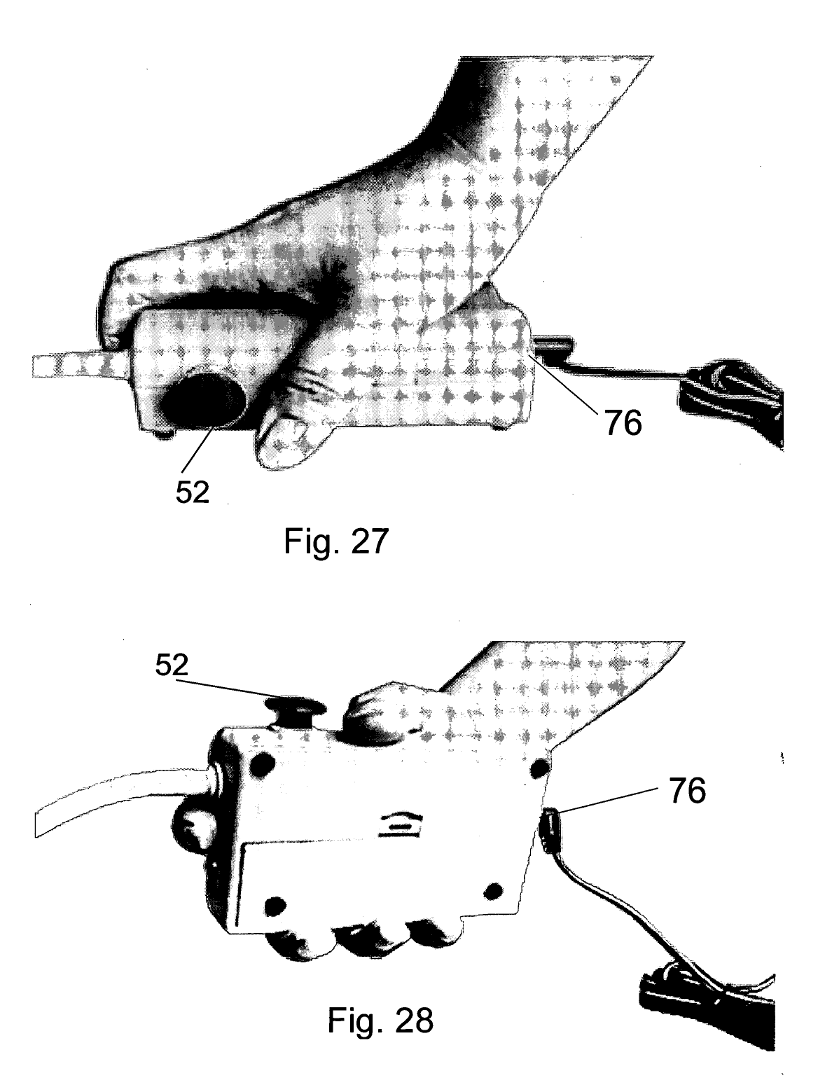

Please see FIGS. 19-24 for the detailed structure of the air pump 50. The air pump 50 comprises mainly a discharge valve button 52, a safety valve plunger 57, a pipe 51 for accommodating the discharge valve button 52 and relevant parts, a second pipe 56 for accommodating the safety valve plunger 57 and relevant parts, a pumping device 53, a pipe 55 in communicating with the pumping device 53, a pipe 54 for accommodating an end of an air tube having another end connected to the air valve of the inflatable massaging device of the present invention, and a starting button 58.

The discharge valve has the button 52, a spring 61, a socket 62, a fixation element 71, a piston 63, and a bolt 64 for fastening the button 52, the fixation element 71, and the piston 63 together, when the button 52 is pushed down, the piston 63, the fixation member 71 and the bolt 64 are pushed down simultaneously, and air can be discharged from an air release hole 77.

The safety valve has the plunger 57, a piston 65, a spring 66, a stopper 67, a micro-adjustment member 70, and two bolts 68 and 69 for fastening the stopper 67 to the pipes 54 and 55. The micro-adjustment member 70 and the stopper 67 have corresponding threads so that the member 70 can be rotated to adjust and set safety pressure which is preferably 0.015 MPA (mega Pascal). When the air pressure in the air tube or pipe 54 is more than the set value, the plunger 57 and the piston 65 is pushed downward by the air pressure and excessive air can be discharged from the air release hole 77.

Indicating light 59 indicates the inflation of the air pump 50, indicating light 60 indicates that the power is “on”, A switch 72 is provided on the housing of the air pump 50, A socket 73 is also provided on the housing of the air pump 50 for the insertion of a plug (line) 76 of an adapter (ac/dc converter), A clip (or hook) 74 is provided on the housing of the air pump 50 for attaching the air pump 50 on a belt or pocket of the user. A battery compartment 75 is also provided on the housing for accommodating batteries.

When the user's hand (finger, preferably forefinger) pushes down the starting button 58, the pumping device 53 is energized to provide air to the air valve on the inflatable massaging device of the present invention through the pipes 53 and 54, and an air tube (not shown in the drawings), and thus the inflatable massaging device is inflated when the user's hand (finger, preferably thumb) pushes down the safety valve plunger 57, air from the inflatable massaging device is discharged at air release hole 77 through the air valve, air tube, and the pipe 54, and thus the inflatable massaging device can be deflated.

In actual use, the user can choose one of the following three ways, or other suitable ways;
1. Push and release: the user continuously inflate the inflatable massaging device until the user can not tolerate, then deflate the same, then inflate and deflate it alternatively;
2. Continuous inflation: the user inflate the inflatable massaging device fully, then discharge about half of the air in that device, and then inflate it fully again. These steps can be repeatedly done.
3. Full inflation and full release: the user inflate the inflatable massaging device fully, then turn off the air pump 50, let the air stay in the inflatable massaging device for a while (eg. 3-5 minutes), then deflate the inflatable massage device. These steps can be repeatedly done.

The purpose of alternatively inflating and deflating the inflatable massaging device is to exert pressure to the user's body part so as to massage it and stimulate pressure points; then let the body part relaxed when it is deflated.

1. An inflatable massaging clothes, comprising mainly as air bladder and a housing outside of the air bladder; at least one air valve; and an air pump; wherein the air bladder and the housing are of a general shape of a clothes, having a back portion, a right front portion, and a left front portion; wherein the left side of the right front portion and the right side of the left front portion are provided with hooks and loops so that the right front portion and the left front portion can be attached together; and wherein a plurality of massage balls are provided on the inside of the back portion, corresponding to some pressure points to be stimulated.

2. The inflatable massaging clothes in claim 1, wherein there are horizontal gussets provided on the upper part of the air bladder; and vertical gussets provided on the back portion and front portions, under the horizontal gussets.

3. The inflatable massaging device as in claim 1, wherein the air pump comprises mainly a housing, a safety valve, a discharge valve, a pumping device, a starting button, and indicating lights.

4. The inflatable massaging device as in claim 3, wherein the safety valve includes a plunger, a piston, a spring, a stopper, a micro-adjustment member, and two bolts.

5. The inflatable massaging device as in claim 3, wherein the discharge valve includes a button, a spring, a socket, a fixation element, a piston, and a bolt.
